(19) United States
(12) Patent Application Publication
(10) Pub. No.: US 2009/0145905 A1
(43) Pub. Date: Jun. 11, 2009

(54) Sliding hatch cover with internal seal for pressurized bulk carriers

(76) Inventor: Sun Y. Kim, Hayward, CA (US)

Correspondence Address: RICHARD ESTY PETERSON;Patent Attorney, Suite D, 1905 Palmetto Avenue, Pacifica, CA, 94044, US

(21) Appl. No.: 11/999,757

(22) Filed: Dec. 6, 2007

(51) Int. Cl. B65D 43/20; B23P 19/04; B65D 51/00

(52) U.S. Cl. 220/345.1; 220/361; 29/700

(57) ABSTRACT

A sliding hatch cover unit for a pressurizable tanker, that carries a dry granular material that is pneumatically discharged, the sliding hatch cover unit having a track mounted hatch cover that can be displaced from a position of safety and a circular hatch port gate that is internally mounted on a hinge within the tank of the tanker through a port in the tank before installation of a port sleeve having a seal engageable with the circular gate in order to use the internal pressure of the tank when pressurized to seal the tank, the gate being hinged and connected to the hatch cover for opening and closing along with the sliding hatch cover.

### BACKGROUND OF THE INVENTION

This invention is an improved slide hatch for bulk carriers and in particular comprises a sliding hatch cover unit with internal seal for pressurizable tanks of the type used for cement tankers. The sliding hatch cover unit includes an actuator system that has an external actuator that displaces both an outside hatch cover and an inside sealing gate. In particular, this invention relates to a hatch cover kit that can be incorporated into a bulk carrier container at the time of manufacture or adapted as a replacement cover system for an after market carrier having a top loading port.

The slide unit hatch can be used on any bulk carrier vehicle of the type used for transport of dry powdered or granular material that is free flowing in a hopper style container. This description utilizes a cement carrier as a preferred example of the transport carrier contemplated. Bulk transport of dry cement is accomplished utilizing a gondola-style trailer that is loaded with cement from a top port by means of a hose or chute. Typically, the gondola has a tank with sloping sides that converge to a bottom discharge for gravity feed of the cement to a discharge hose that is used to pneumatically deliver the bulk cement to a destination for storage or mixing. To assist in the discharge of the fine powder cement, the gondola tank is pressurized to both compensate for volumetric displacement by the discharging cement and to assist in moving the cement to the discharge pump.

To maintain a pressure within the gondola tank, the hatch cover must have a sealed engagement with the hatch port at the top of the tank. Typically, the hatch cover is connected to the tank with a hinge and a series of threaded dogs mounted around the hatch cover. When the tank is refilled, the hatch cover must be opened which has customarily required that the driver or assistant climb to the top of the trailer and manually disengage the tie-down dogs to open the hatch. Not only is this task time consuming, but because of the configuration of the tank and carrier trailer the task is dangerous as well.

The sliding hatch cover unit of this invention relates to my U.S. Pat. No. 6,196,590, entitled “Slide Hatch for Bulk Carrier”, issued Mar. 6, 2001. In the referenced patent, a hatch cover is designed to slide over a hatch port on a track that by cam action forces the cover onto a seat around the port.

A considerable force is applied to the hatch cover when the tank is even moderately pressurized to 15 p.s.i. for fluidizing and pneumatically conveying the tank contents from the tankers.

When the bulk material is a dry powder such as cement, that tends to build-up on the cover seat, the seal begins to fail after a number of transport operations. A leaking access hatch lowers the internal tank pressure and delays the unloading process.

Internal sealing has the advantage of utilizing the force developed by the tank pressure to improve the seating and seal. However, locating an actuator assembly within a tank loading and unloading material like cement is preferably to be avoided to prevent frequent servicing in a difficult environment.

The subject invention avoids this disadvantage by mounting the primary actuator assembly external to the tank. The use of an internal sealing gate and an outside protective cover improves the longevity of the system before maintenance and cleaning is required.

In the preferred embodiment described, the cover and gate are linked with the external actuator to reciprocally slide the outer cover and raise and lower the inner gate.

It is to be understood that the sliding hatch cover unit of this invention can be utilized with a cam assisted covering system as described in the referenced patent with the primary function of the hatch cover being to cover and protect with sealing accomplished by the internal gate.

In the preferred embodiments of this invention the gate is linked to the cover by cables and operated in conjunction with the sliding of the cover as further described in the summary and detailed description of this invention.

### SUMMARY OF THE INVENTION

The sliding hatch cover unit of this invention is designed for a pressurizable tanker, which carries a dry granular material that is pneumatically discharged. The sliding hatch cover unit has a track mounted hatch cover that can be displaced from a position of safety. In the embodiment disclosed, the hatch cover unit includes a hatch port gate that is internally mounted within the tank of the tanker in order to use the internal pressure of the tank when pressurized to seal the tank.

In the embodiments of the sliding hatch cover unit described, the actuator mechanism that slides the hatch cover to an open position and a closed position also actuates the internal hatch port gate. In the preferred embodiment, a piston and rod actuator mechanism is connected to the hatch cover to open and close the hatch cover. The actuator mechanism preferably utilizes a pair of compact hydraulic actuators arranged on each side of the sliding hatch cover. It is to be understood that a single rod and piston actuator that may be air driven may be utilized instead of the preferred dual actuator system. Alternately, a mechanical winch and spring return system may be employed.

In order to overcome the problem of pressure leakage around the closed hatch cover during the process of pressurizing the tank for discharge of the contents, the sealing is accomplished from the inside the tank. In this manner, the force of the internal air pressure against the closure member aids in sealing the tank. The closure member comprises a hinged flap plate that engages a gate seat on the inside of the tank port to seal the tank chamber.

The flap plate is hinged at one side to an internal mount on a cylindrical sleeve that is a component of the hatch cover kit. The plate is actuated by a cable that connects the plate to the sliding hatch cover in a manner that closes the flap plate against the gate seat when the cover is closed. When the cover is opened, the plate drops open by force of gravity.

Whether the sliding hatch cover is actuated by action of a manually operated cable system or by action of a rod in a pneumatic cylinder actuator, the displacement of the hatch cover is translated to the displacement of the hinged plate for sealing the hatch port.

In order to adapt the hatch cover kit to an existing bulk carrier tank, the adaptation must be easily accomplished with minimal modification to the existing cover system. Of primary concern is the ability to install a rugged system that will withstand the abuse of the loading mechanism and wear from often abrasive material.

Additionally, key components, such as the flap plate, must be installed through the loading port of the carrier tank. Repair and replacement of the components must be easily accomplished and, preferably, the cover system should be removable and usable as a unit on another bulk carrier tank.

These and other features will become apparent on considering the preferred embodiment described in the detailed specification that follows.

### BRIEF DESCRIPTION OF THE DRAWINGS

FIG. 1 is a perspective view of a bulk carrier tanker with a sliding hatch cover unit, with piston and rod actuator units arranged on each side of one of the top hatches.

FIG. 2 is perspective view of a portion of the tank of the bulk carrier and a part of the sliding hatch cover unit without the actuator system.

FIG. 3 is a top plan view of the sliding hatch cover unit with the cover in the open position and with portions of the cover unit broken away to reveal underlying components.

FIG. 4 is an end view of the sliding hatch cover unit with part of the tank of the bulk carrier shown in cross section.

FIG. 5 is a side elevational view of the hatch cover unit of FIG. 4 partially in cross section with the internal flap plate in an open position.

FIG. 6 is a side elevational view of the hatch cover unit of FIG. 4 partially in cross section with the internal flap plate in a closed position.

### DETAILED DESCRIPTION OF THE PREFERRED EMBODIMENTS

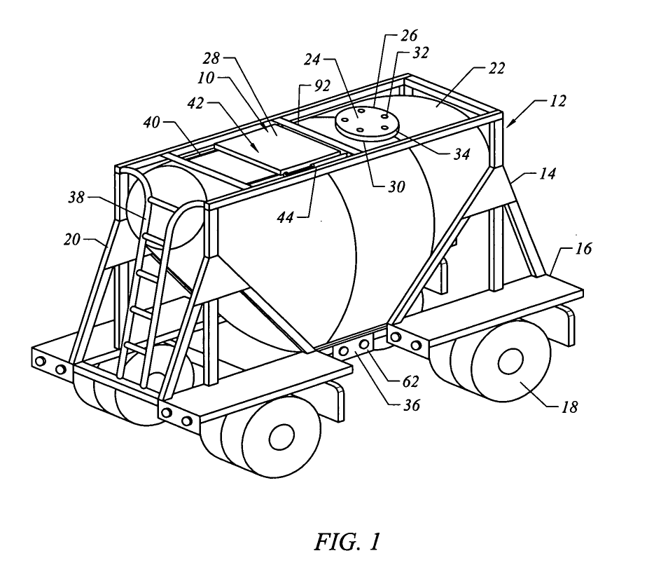

Referring to FIG. 1, the sliding hatch cover unit of this invention is designated by the reference numeral 10 and is incorporated onto a bulk carrier 12 in the form of a cement tanker 14. The cement tanker 14 has a trailer carriage 16 with wheels 18 and a frame 20 that supports and contains a pressurizable tank 22.

The tank 22 typically has one or more hatches 24 with hatch covers 26 and 28 covering an opening or port 30 for filling the tanker with dry granular powdered material such as bulk cement.

A conventional hatch cover 26 has a series of perimeter bolts 32 which secure the cover 26 to an elevated rim 34, which allows the tank to be pressurized for discharge of the contents of the tank 22. Typically a discharge hose or pipe (not shown) is connected to a discharge unit 36 at the bottom of the tank 22. The released pressurized air fluidizes the contents during the discharge and pneumatically conveys the fluidized powder material to a delivery terminal.

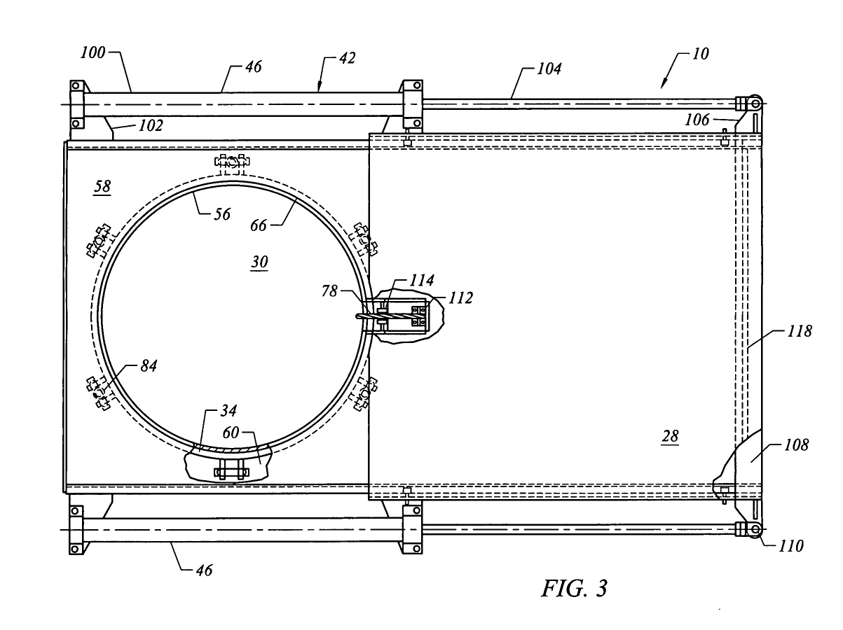

Climbing to the top of the tank 22 on the ladder 38 at one end of the tanker 14 to undo the bolts 32 is a danger and inconvenience to an operator. To remedy this situation at least one hatch cover 28 can be removed from a position of safety. Referring to FIG. 1, the hatch cover 28 is part of the sliding hatch cover unit 10 which includes, in addition, a pair of slide tracks 40 adjacent each side of the rectangular or square hatch cover 28 and an actuator assembly 42. The actuator assembly 42, as shown in FIG. 1, schematically comprises a pair of piston and rod units 46 as shown in greater detail in FIG. 3. Preferably, the piston and rod actuator assembly 42 can be actuated from inside the vehicle cab (not shown) or by the controls at the side of the tanker.

In addition, the sliding hatch cover unit 10 includes an internal gate 48 that is preferably actuated by the actuator assembly 42 to seal the tank 22 when the hatch cover 28 is positioned over the port 30. Preferably, the hatch cover unit 10 is in the form of a compact kit that can easily be installed on an existing bulk carrier with minimal modification.

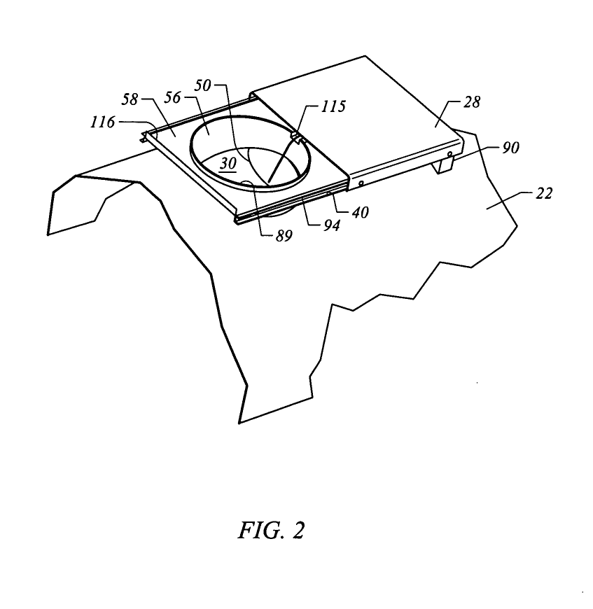

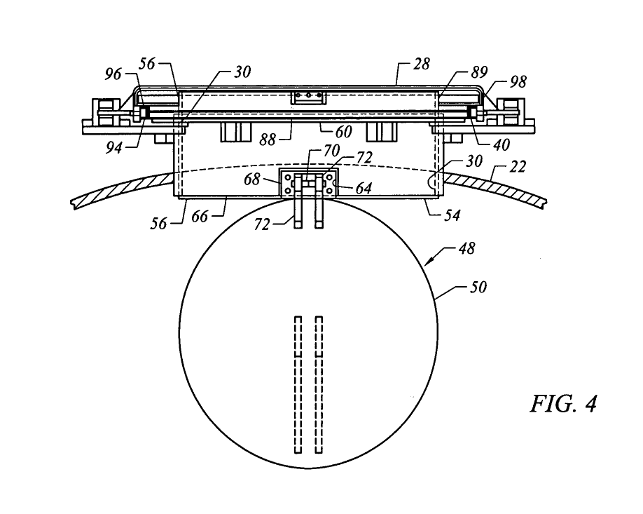

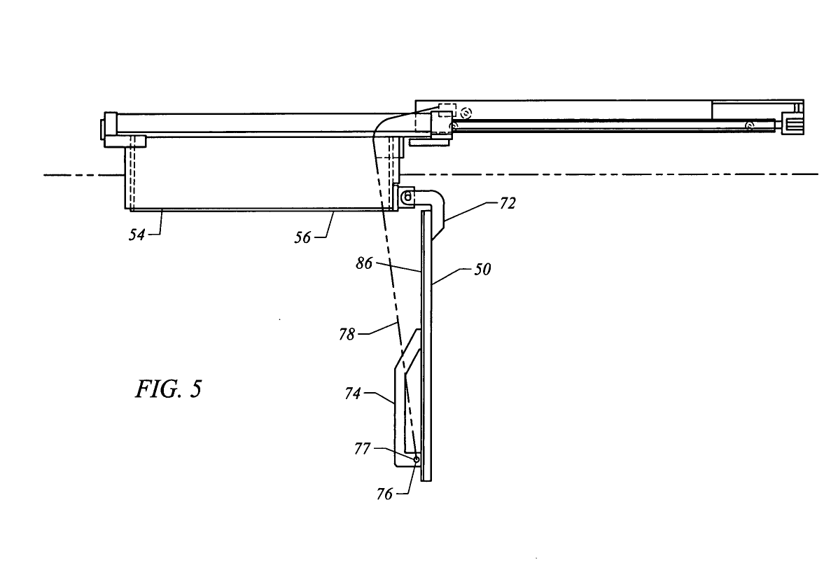

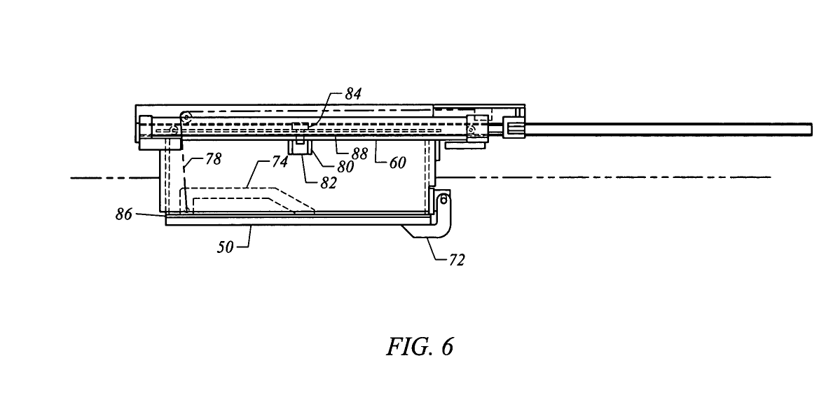

In the embodiment of FIGS. 2-6, the gate 48 is in the form of a circular flap plate 50. In the process of pressurizing the tank 22, the internal pressure will force the plate 50 against an internal gate seat 54 and seal the tank 22.

In the preferred embodiment, the gate seat 54 is located at the end of a cylindrical guide sleeve 56 installed within the tank 22. In the preferred embodiment shown, the sliding hatch cover unit 10 is incorporated onto an existing tanker 14 with minimal modification, using the installation method disclosed. A typical tanker 14 has one or more hatches 24 with elevated rims 34, having a flange 60 around the circular port 30 for attachment of a cover.

In the preferred embodiment, the sliding hatch cover unit 10 is connected to the port flange 60 and is supported in part on the top surface of the typical tank 22 of a bulk carrier 12 as an integrated assembly kit. The compact actuator assembly 42 includes a conventional hydraulic system 62, indicated schematically, that includes the hydraulic and electronic controls (not shown) for remote actuation by a driver in the cab of the carrier and/or at the side of the tanker 14.

To install the hatch cover unit 10, a notch 64 is cut into the lower portion of the original cylindrical port wall 66 that downwardly projects into the interior of the tank 22 to guide the hose or chute during the filling operation. This notch 64 allows a clevis bracket 68 to connect to the lower edge of the guide sleeve 56 without having to extend the guide sleeve 56 beyond the lower edge of the original port wall 66. The clevis bracket 68 is hingedly attached by a pin 70 to a projecting bifurcated tongue 72, extending from the underside of the circular flap plate 50. The circular flap plate 50 is sized with an outer diameter substantially equal to the inside diameter of the port 30 to enable the flap plate 50 to be inserted into the tank 22 through the port 30 before the guide sleeve 56 is inserted, which thereafter reduces the effective diameter of the port 30. The flap plate 50 has a handle bracket 74 on its upper surface that includes a hole 76 for an anchor pin 77 for anchoring a closure cable 78. The closure cable 78 and handle bracket 74 provide a convenient means to retrieve the suspended flap plate 50 for fastening after the guide sleeve 56 is inserted into the port 30 and the attached bib plate 58 is seated and bolted onto the existing flange 60 of the rim 30. In many instances, the existing dog bolt brackets 80 can be fitted with bolt sockets 82 to connect the bib plate 58 to the rim flange 60 with a series of spaced bolts 84 without substantial modification. After seating and securing the bib plate 58 and depending guide sleeve 56 to the port flange 60, the clevis bracket 68 can be attached to the guide sleeve 56. If the flap plate 50 is not already connected to the clevis bracket 68, then the plate is connected to the bracket 68 with the pin 70.

This design and method of installing the flap plate 50 and guide sleeve 56 enables the diameter of the hatch opening to be reduced only by the thickness of the guide sleeve 56 and allows the internal flap plate to be mounted as high as possible within the tank 22. In this manner, the customary loading systems can be used and the downward swing of the cover is minimized. Care must be taken in order not to overfill the tank 22, making it difficult to swing the flap plate 50 to the closed position.

The flap plate 50 has a perimeter seal 86 on the upper or top surface that contacts the gate seat 54 to seal the tank 22, particularly when the tank 22 is pressurized, forcing the flap plate 50 against the gate seat 54 of the guide sleeve 56. Between the flange 60 of the rim 34 of the tank port 30 and the underside of the bib plate 58 is a seal 88 which becomes air tight when the guide sleeve 56 and bib plate 58 are installed and secured by the perimeter bolts 84. In this manner, the sliding hatch cover 28 is not required to provide an air tight seal, but merely covers the port 30 to prevent debris or water from entering that portion of the guide sleeve 56 between the closed flap plate 50 and the upper rim 89 of the guide sleeve 56 which projects above the bib plate 58.

To displace the sliding hatch cover 28 and swing the hinged flap plate 50, the actuator assembly 42 is actuated. The actuator assembly can be a simple mechanical system with a crank and spring return, as proposed in my earlier application, or a single or double piston and rod unit. Preferably, the actuator assembly 42 is a hydraulic system with two piston and rod units 46 mounted on each side of the tank port 30 for simultaneous operation.

The bib plate 58 is generally rectangular and extends over a portion of the top of the tank 22. The bib plate 58 is supported at the far end by a shell bracket 90 that seats on the top of the tank 22 as shown in FIG. 2. The side edges 92 of the bib plate 58 have U-shaped side channels 94 that form tracks 40 for side rollers 96 on downwardly directed cover guides 98 that comprise the sides of the hatch cover 28. The heavier cylinder piston component 100 of each piston and rod unit 46 are mounted to support brackets 102 extending from the underside of the bib plate 58 on each side of the port 30. The lighter rod component 104 of the piston and rod unit 46 projects from the piston cylinder component 100 and connects to the outwardly extending end 106 of a cross member 108 at one edge of the sliding hatch cover 28 by pin 110. In this manner, actuation and extension of the rod component 104 displaces the cover 28 exposing the port 30.

The closure cable 78, which is attached to the anchor pin 77 of the flap plate 50 at one end, is anchored to a cable retainer 112 on the top side of the bib plate 58 at its other end. When the cover 28 is displaced, the closure cable 78 simultaneously slackens and lowers the flap plate 50, thereby opening the port for filling. The closure cable 78 is carried over a pulley assembly 114 mounted on the underside of the cover 28 and through a notch 115 in the upper rim 89 of the guide sleeve 56 and causes the flap plate 50 to lift when the rod component 104 is retracted and the cover 28 displaced to the closed position, stretching the closure cable 78 over the port opening. As apparent, the cable 78 in the open position is out of the way and does not interfere with the filling of the tank 22. The bib plate 58 has a cross seal 116 that provides a cover stop and front cover seal on closure, and a cross seal 118 mounted under the cover adjacent the cross member 108 that connects to the piston and rod units 46. In this manner, with only minor modification to the existing hatch, a sliding hatch cover 28 can be installed as a unit to an existing port 30.

While, in the foregoing, embodiments of the present invention have been set forth in considerable detail for the purposes of making a complete disclosure of the invention, it may be apparent to those of skill in the art that numerous changes may be made in such detail without departing from the spirit and principles of the invention.

1. In a bulk carrier having a pressurized carrying tank for granular materials that has one or more cylindrical access ports at the top of the carrying tank with the access ports having a raised circular rim that typically supports a cover bolted to the rim, the improvement comprising a sliding hatch cover kit that couples to the raised rim of at least one of the access ports and comprises:
a sliding hatch cover unit mounted on the top of the tank having a pair of slide tracks positioned on each side of the cylindrical access port;
a sliding cover having cover supports that engage the slide tracks wherein the sliding cover is movable from a position over the raised rim covering the access port to a position displace from the rim;
an actuator assembly connected in part to the cover wherein the cover is reciprocally displaceable from a first position covering the port and a second position displaced from the port by the actuator; and,
a cylindrical port guide sleeve wherein the access port has an inside diameter and the port guide sleeve has an outside diameter substantially equal to the inside diameter of the port, the port guide sleeve having a circular flap plate with a diameter substantially equal to the outer diameter of the guide sleeve wherein the guide sleeve has a gate seat to seal the port from within the tank, wherein the flap plate is inserted into the port before the guide sleeve is installed and connected to the inserted flap plate and is connected to the slide cover for closure on closure of the slide cover.

2. The improved sliding hatch cover kit of claim 1 wherein the flap plate is connected to the slide cover by a cable.

3. The improved sliding hatch cover kit of claim 2 wherein the flap plate is connected to the guide sleeve by a hinge.

4. The improved sliding hatch cover kit of claim 1 wherein the sliding hatch cover unit includes a support structure wherein the support structure is mounted on the raise rim and has a side part that includes the pair of slide tracks on each side of the cylindrical access port.

5. The improved sliding hatch cover kit of claim 4 wherein the support structure has an end part that extends over a portion of the top of the carrying tank and includes a support bracket that rests on the tank to support the end part that extends over the tank.

6. The improved sliding hatch cover kit of claim 5 wherein the side part and end part comprise a substantially flat bib plate around the guide sleeve.

7. The improved sliding hatch cover kit of claim 6 wherein the raised rim has a rim seal and the bib plate is seated on the rim seal and secured to the rim.

8. The improved sliding hatch cover kit of claim 7 wherein the bib plate is fixed to the cylindrical port guide sleeve.

9. The improved sliding hatch cover kit of claim 8 wherein the bib plate, guide sleeve and rim seal are interconnected in a manner that prevents pressurized air from passing between the cylindrical access port and the guide sleeve.

10. The improved sliding hatch cover kit of claim 4 wherein the actuator assembly includes at least one hydraulic actuator having a piston cylinder component and a rod component with one of the piston cylinder component and rod component being connected to the support structure and the other of the piston cylinder component and rod component connected to the sliding cover.

11. The improved sliding hatch cover kit of claim 10 wherein the actuator assembly includes two hydraulic actuators with one actuator on one side of the access port and the other actuator on the other side of the access port wherein the support structure of the sliding hatch cover unit has side brackets and the sliding cover has a cross bracket, wherein the piston cylinder components of the hydraulic actuators are connected to the side brackets and the rod components of the hydraulic actuators are connected to the cross bracket.

12. The method of coupling a sliding hatch cover kit to a conventional bulk carrier having a pressurized carrying tank for granular materials wherein the tank has a top with one or more access ports having a raised circular rim with a cover and a cylindrical port opening having an inside diameter wherein the steps comprise:
removing the cover of at least one access port;
inserting circular flap plate having an outer diameter slightly less than the diameter of the port opening;
installing a cylindrical sleeve having an outside diameter substantially equal to the inside diameter of the port opening, wherein the inside diameter of the sleeve is less than the outside diameter of the flap plate and wherein the cylindrical sleeve when installed has an end seat in the tank;
pivotally connecting the flap plate to the sleeve with the flap plate being pivotal from an open position to a closed position against the end seat; and,
connecting the flap plate to an actuator unit that includes a sliding cover that is positionable over the port when the connected flap plate is closed on actuation of the actuator unit.
